(19) United States
(12) Patent Application Publication
(10) Pub. No.: US 2021/0176249 A1
(43) Pub. Date: Jun. 10, 2021

(54) MOBILE NETWORK-BASED MULTI-FACTOR AUTHENTICATION

(71) Applicant: Zumigo, Inc., San Jose, CA (US)

(72) Inventors: Chirag C. BAKSHI, San Jose, CA (US); Harish MANEPALLI, San Jose, CA (US); Venkatarama PARIMI, Dublin, CA (US)

(21) Appl. No.: 17/107,649

(22) Filed: Nov. 30, 2020

Related U.S. Application Data
(63) Continuation of application No. 16/168,713, filed on Oct. 23, 2018, now abandoned.
(60) Provisional application No. 62/576,062, filed on Oct. 23, 2017.

(51) Int. Cl. H04L 29/06; H04W 12/00

(52) U.S. Cl. CPC H04L 63/0876; H04L 2463/082; H04W 12/00514; H04W 12/00503

(57) ABSTRACT

A computer-implemented method of authenticating a user logged into a restricted-access account over a computer network, includes the steps of: receiving a request to authenticate the user over the computer network; verifying that authentication data of the user matches verification data that is acquired over the computer network and associated with a network identification of a mobile device that is linked to the restricted-access account of the user; verifying that a location of an IP address from which the user is accessing the restricted-access account matches a current location of the mobile device; and authenticating the user upon determining that the authentication data of the user matches the verification data and the location of the IP address matches the current location.

### BACKGROUND OF THE INVENTION

### Field of the Invention

Embodiments of the present invention generally relate to identity authentication systems and, more specifically, to multi-factor authentication of on-line transactions.

### Description of the Related Art

Unlike credit cards that employ magnetic ribbons for carrying sensitive information, chip-based credit cards are not easily reproducible. Thus, with the advent of chip-based credit cards, fraudulent duplication of a credit card using no more than a stolen credit card number and readily accessible magnetic strip-encoding equipment is no longer feasible. Consequently, credit card fraud associated with stolen credit card numbers is now shifting to online purchases. As a result, e-merchants currently face increasing incidences of fraudulent transactions in the realm of card not present (CNP) transactions.

To enhance the security of CNP transactions, some e-merchants require certain user or account information to be entered by a customer in addition to the credit card number, and such information is employed as an additional authorization factor. For example, e-merchants now typically require not only a credit card number to authorize an online transaction, but also appropriate identity information associated with the user of the credit card number, such as the user name and billing address. However, a fraudster can still successfully complete a fraudulent online transaction when this additional authorization factor is employed. For instance, fraudsters are now making fraudulent transactions with stolen credit card numbers used in conjunction with stolen identity information, such as the user name and billing address of the authorized user of a stolen credit card number.

To further enhance the security of CNP transactions, some online merchants require additional information to be entered by an online customer, and this additional information is employed as a further authorization factor. For example, online merchants may require entry of a mobile number of a mobile device that is associated with the authorized user of the credit card. Given a specific mobile number, certain third-party technologies are available to online merchants that report the name of the registered user of the mobile device with that mobile number to the online merchant. Thus, when the reported name does not match the user name of the credit card number being used in a transaction, the online merchant does not authorize the online transaction. However, when a fraudster is in possession of a stolen credit card number and the user name associated with the credit card number, the fraudster can defeat this additional authorization factor by opening a mobile account for a pre-paid cell phone in the name of the authorized user of the stolen credit card. At the time of an online transaction, the online merchant requests the currently registered user name associated with the mobile number entered at the time of the transaction, and the third party returns the name of the user of the credit card. Thus, the online merchant cannot identify a fraudulent transaction when a fraudster has stolen both a credit card number and the associated user name.

### SUMMARY OF THE INVENTION

According to various embodiments, a fraudulent online payment transaction involving a stolen account number, e.g., credit card account number, is prevented via a multiple factor authentication of the transaction. Specifically, when an online payment transaction is initiated from a computing device, a mobile device that is associated with the account is employed as a physical token, and the online payment transaction is authorized based on possession of the mobile device. Real-time information associated with the user initiating the online payment transaction and real-time information associated with the mobile device are employed to verify user identity and user location. User identity is verified by comparing the name associated with the online payment transaction with the name that is currently registered as the user name for a mobile device. User location is verified by comparing the location at which the online payment transaction is initiated with the current location detected for the mobile device. Thus, the mobile device acts as a physical authorization token when authorizing the online payment transaction. In some embodiments, the multiple factor authentication further includes verification that user account information, such as user name and full user address, matches corresponding account information that is currently associated with the mobile device.

According to further embodiments, a fraudulent attempt at opening an account in another person's name, e.g., a credit card account, is prevented via a multiple factor authentication method that relies on possession of a mobile device of the other person. The method includes the steps of receiving a request for verifying an identity of a user attempting to open an account, the request including a first user name associated with the account, verifying that the first user name matches a second user name that is currently registered as a user name for a network identification (ID) of the mobile device, verifying that a current location of the user attempting to open the restricted-access account matches a current location of the mobile device, and determining an identity verification score for the user attempting to open the restricted-access account based on verifying that the first user name matches the second user name and on verifying that the current location of the user matches the current location of the mobile device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a mobile identity verification system, according to one or more embodiments of the present invention.

FIG. 2 schematically illustrates the steps performed by the mobile identity verification system of FIG. 1 when performing multi-factor authentication, according to one or more embodiments of the invention.

FIG. 3 schematically illustrates the steps performed by the mobile identity verification system of FIG. 1 when performing multi-factor identity verification, according to one or more embodiments of the invention.

For clarity, identical reference numbers have been used, where applicable, to designate identical elements that are common between figures. It is contemplated that features of one embodiment may be incorporated in other embodiments without further recitation.

### DETAILED DESCRIPTION

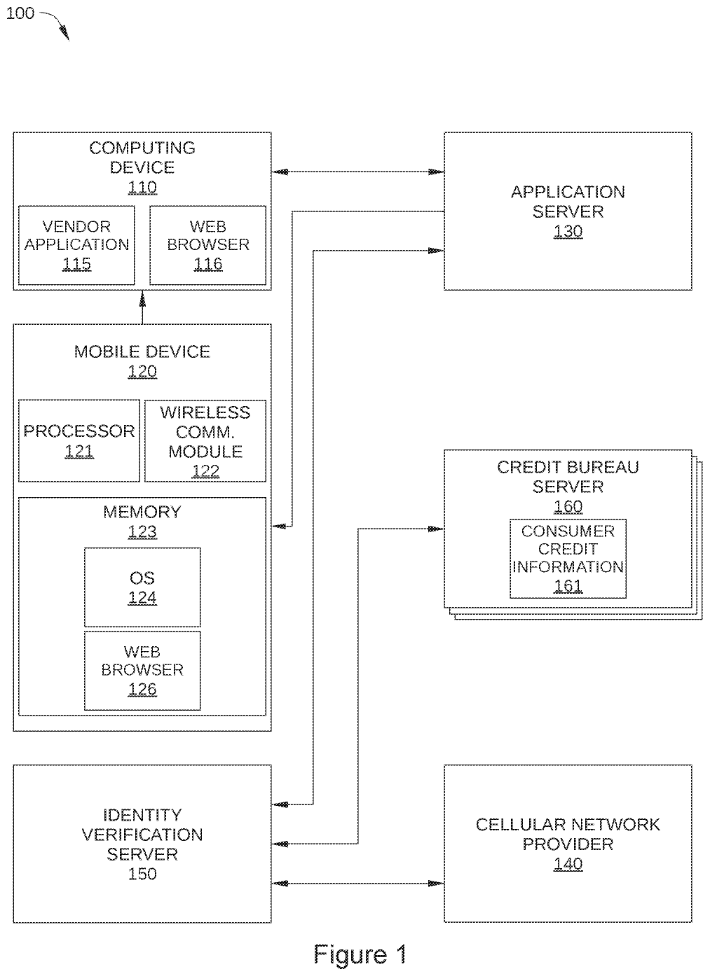

FIG. 1 is a block diagram of a mobile identity verification system 100, according to one or more embodiments of the present invention. As described below, mobile identity verification system 100 enables verification of the identity of a user based on possession of a smartphone, wireless subscriber terminal, or other mobile device. Thus, the mobile device is employed as a physical token that is a verification factor for an online credit card transaction. Further, in some embodiments, the mobile device is employed as a physical token that is a verification factor for registering or opening a restricted access account via an online process.

Mobile identity verification system 100 includes a computing device 110, a mobile device 120, an application server 130, a cellular network provider 140, an identity verification server 150, and one or more credit bureau servers 160. Although not shown in FIG. 1, mobile device 120 can be communicatively coupled to application server 130 by one or more wireless communication networks, and identity verification server 150 can be communicatively coupled to application server 130, cellular network provider 140, and credit bureau servers(s) 160 by one or more wireless communication networks, and computing device 110 can be communicatively coupled to application server 130 by one or more wireless communication networks.

The one or more wireless communication networks connecting the above elements of mobile identity verification system 100 can each include a wireless local area network (WLAN), a cellular network, or a combination of both. The WLAN included in the one or more one or more wireless communication networks enables compatible devices to connect to the Internet via a wireless access point, or “hotspot.” For example, in some embodiments, the WLAN is a WiFi network that includes one or more devices based on the Institute of Electrical and Electronics Engineers (IEEE) 802.11 standard. Thus, any suitably configured wireless communication device that can connect to the WLAN, such as a smartphone with WiFi capability, can perform data transfer to and from the Internet. The cellular network included in the one or more wireless communication networks enables two-way wireless communication with wireless subscriber terminals, such as mobile device 120. For example, in some embodiments, the cellular network includes one or more base stations (not shown) that are in two-way wireless communication with wireless subscriber terminals, and with a landline system (not shown), such as the public switched telephone network (PSTN) or any other wired network capable of voice/data connections. When an active call associated with mobile device 120 is underway in the cellular network, a suitable base station translates a forward trunk signal in the landline system to a properly formatted radio signal, which is transmitted by an antenna to mobile device 120 over an air interface. Mobile device 120 performs complementary operations to enable the two-way voice or data traffic over the air interface.

Computing device 110 can be any technically feasible and network-connected computing device. For example computing device 110 can be a desktop computer, laptop computer, smartphone, personal digital assistant (PDA), tablet computer, or any other type of computing device that is configured to receive input, process data, and display images, and is suitable for practicing one or more embodiments of the present invention. Thus computing device 110 is configured to execute a vendor application 115, a web browser 116, and/or other software applications. In addition, computing device 110 is configured to communicate with application server 130, for example via a web browser 116.

Vendor application 115 is a computer program designed to run on computing device 120. Vendor application 115 is loaded on computing device 110 and facilitates interactions with a particular website, such as application server 130, a particular database, or some other computing device. For example, in some embodiments, vendor application 115 is a banking application, a navigational program, an application that facilitates online purchasing of entertainment media from a specific website, etc. In some embodiments, vendor application 115 enables online purchases via credit-card transactions with application server 130. Alternatively or additionally, in some embodiments, web browser 116 enables online purchases via credit-card transactions with application server 130.

Mobile device 120 can be a cellular telephone, a smart phone, a personal digital assistant (PDA), a tablet computer, or any other mobile computing device or wireless subscriber terminal configured to wirelessly access WLANs and cellular networks of mobile identity verification system 100, and to facilitate one or more embodiments of the present invention. To that end, in some embodiments, mobile device 120 includes a processor 121, a wireless communication module 122, and a memory 123. Processor 121 may be any suitable processing unit implemented as a central processing unit (CPU), an application-specific integrated circuit (ASIC), a field programmable gate array (FPGA), any other type of processing unit, or a combination of different processing units. Wireless communication module 122 may be any suitable electronics package and or chipset configured to enable wireless communication with a WLAN and/or cellular network. Thus, in some embodiments, wireless communication module 122 includes cellular capability and WiFi capability, among others. Alternatively or additionally, in some embodiments, wireless communication module 122 includes Bluetooth capability. Memory 123 can include any suitable volatile and/or nonvolatile memory (e.g., random-access memory (RAM), read-only memory (ROM), flash memory, a magnetic hard drive, etc.), and is configured to store instructions, data, an operating system (OS) 124, and/or a web browser 126, etc.

OS 124 supports the functions of processor 121, including scheduling tasks and sending commands to vendor application 125, memory 123, and wireless module 122, managing the power state of mobile device 120, initiating execution of applications on processor 121, managing sockets and TCP connections, and the like. For example, in some embodiments, OS 124 is configured to facilitate the execution of web browser 126, and/or other software applications.

Mobile device 120 is programmed with a network identification (ID). The network identification ID of a mobile device, as used herein, can include the mobile number or other unique number that is associated with that mobile device and is managed by a cellular network provider.

Application server 130 can be any entity that can be accessed by mobile device 120 via WiFi or another communications network and can benefit from identification and/or authorization of a user prior to access by the user. More specifically, application server 130 can be any entity that provides access to a vendor website, a restricted-access account, or other sensitive information. Alternatively or additionally, application server 130 enables important data and/or financial transactions. Application server 130 can be implemented as a website, an application, a server, a database, an application running on an instance of virtual machine, and the like. Thus, in some embodiments, application server 130 is a public or open server, whereas in other embodiments, application server 130 is a restricted-access only server. For example, in some embodiments, application server 130 can be a restricted-access server, a merchant server, a vendor website, an e-mail server or application that enables interaction with an e-mail server, a banking website, a cloud storage server, and the like. Thus, application server 130 can be any computing device, application, or other entity that can be accessed by computing device 110 via web browser 116. As noted above, vendor application 115 is configured to facilitate access to and interactions with application server 130.

In some embodiments, application server 130 stores and/or provides access to sensitive information and/or enables important data and/or financial transactions. For example, application server 130 can be a customer-facing server of an online merchant, and facilitates online credit card transactions from a user of computing device 110.

Cellular network provider 140 represents one or more computing devices or servers included in cellular network 102 that are employed by the provider of cellular network 102 for communicating control, status, and signaling information between nodes in cellular network 102. In some embodiments, cellular network provider 140 is included in a Signaling System 7 (SS7) network. In some embodiments, cellular network provider 140 includes the capability of cellular network 102 to allocate Internet protocol (IP) addresses to mobile devices 120 and to map currently allocated IP addresses to the network IDs of mobile devices 120. In some embodiments, cellular network provider 140 can be determined for a particular mobile device 120 based on the network ID or Mobile Directory Number (MDN) of the mobile device 120. The MDN for a mobile device is generally the 10-digit telephone number that is dialed to reach a CDMA or TDMA mobile device.

Each credit bureau server 160 includes one or more computing devices, servers, and/or databases associated with a particular credit reporting agency, for example Equifax, Experian, or TransUnion. Such credit reporting agencies are companies that collect and maintain consumer credit information 161 for individuals, including personal identifying information, (such as name, date-of-birth, social security number, etc.), historical information, such as residence address history and credit history, and the like. Thus, a credit bureau server 160 can receive certain personal identifying information (such as name, address, date of birth, social security number) and a credit card account number and verify whether personal identifying information is associated with that credit card account number.

Identity verification server 150 may be an application that runs on a server or other computing device coupled to the Internet or other communications network, and is configured to execute identity verification operations as described herein. Such operations can include interfacing with application server 130, cellular network provider 140 and/or one or more credit bureau servers 160, and determining whether a user name associated with mobile device 120 matches a user name associated with a restricted-access account associated with application server 130.

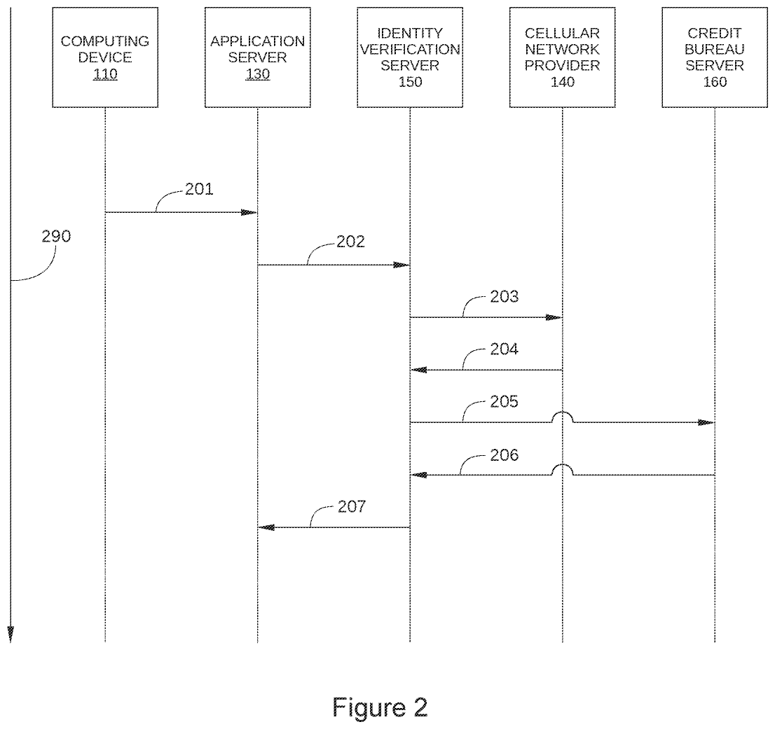

According to various embodiments described below, a credit card transaction initiated via computing device 110 can be authorized via a multi-factor authorization scheme. In such embodiments, the multi-factor authorization scheme is based on the network ID of mobile device 120, where the identity of a user attempting the credit card transaction can be verified using real-time information that is determined from the network ID. More specifically, the identity of a user attempting the credit card transaction can be verified by 1) comparing the user name associated with the online transaction with the name that is currently registered as the user name for mobile device 120, 2) comparing the location at which the online transaction is initiated with the current location detected for mobile device 120, and 3) confirming that the name (and/or other user account information) currently registered as the user name for mobile device 120 matches the user name (and/or other user account information) currently associated with the credit card account number used in the credit card transaction. One such embodiment is described below in conjunction with FIG. 2.

FIG. 2 schematically illustrates the steps performed by mobile identity verification system 100 when performing multi-factor authentication, according to one or more embodiments of the invention. The steps occur sequentially along a time line 290. As described above, mobile identity verification system 100 enables electronic verification of the identity of a user attempting to perform an online payment transaction via a multi-factor authorization scheme.

When a user of computing device 110 attempts to initiate an online payment transaction, in this example, a credit card (or debit card) transaction, via application server 130, vendor application 115 (or web browser 116) transmits a transaction request 201 to application server 130. For example, after a connection is established between computing device 120 and application server 130, a user may fill out an online transaction form displayed on a display device of computing device 110 to initiate transaction request 201. The online transaction form may be displayed by, for example, vendor application 115 or web browser 116 when connected to application server 130. Transaction request 201 can include a user name and credit card account number. In some embodiments, transaction request 201 can further include additional user account information, such as a complete street address and mobile device network ID (mobile number for mobile device 120) linked to the credit card account number.

Upon receipt of transaction request 201, application server 130 then transmits a request for identity verification 202 to identity verification server 150. Request for identity verification 202 generally includes the user name and credit card account number. In some embodiments, request for verification 202 also includes the network ID of the mobile device 120 linked to the credit card account number.

Upon receipt of request for identity verification 202, identity verification server 150 performs a multi-factor authentication process that includes: verifying the user name included in request for identity verification 202 matches the user name currently registered as a user name for the network identification ID of mobile device 120; verifying an initiation location of the online transaction associated with transaction request 201 matches a current location of mobile device 120; and verifying the user name (or additionally other user account information) included in request for identity verification 202 matches a name (or additionally other user account information) currently registered as a user name for the credit card account number included in request for identity verification 202. The multi-factor authentication process may further include determining an authorization score for the on-line transaction based on the above verification steps. Performance of the above verification steps can be in any technically feasible order, and are described herein in one example order.

In a first portion of the multi-factor authentication process, identity verification server 150 verifies that the user name included in request for identity verification 202 matches the user name currently registered as a user name for the network identification ID of mobile device 120 by transmitting a user profile information request 203 to the cellular network provider 140 that manages the network ID referenced in request for identity verification 202. In some embodiments, the user profile information request 203 includes a request for the name and address of the primary user of the mobile account associated with the network ID referenced in request for identity verification 202. In some embodiments, identity verification server 150 first determines the cellular network provider 140 that manages the network ID referenced in request for identity verification 202, for example based on the network ID. Identity verification server 150 then receives user account information 204 from cellular network provider 140, where user account information 204 includes, for the mobile account associated with the network ID, a mobile account user name and, in some embodiments, a mobile account user address. In some embodiments, user account information 204 further includes current location information for mobile device 120. Identity verification server 150 then verifies whether the user name included in request for identity verification 202 matches the user name included in user account information 204.

In embodiments in which the online credit-card transaction is initiated via a mobile device 120, computing device 110 and mobile device 120 can be the same device. In such embodiments, identity verification server 150 or application server 130 can determine network ID automatically. For example, in some embodiments, application server 130 can query a cellular network provider 140 for the network ID based on an Internet Protocol (IP) address included in transaction request 201. Alternatively, in such embodiments, application server 130 or identity verification server 150 can query a mobile device identification server for the network ID based on the IP address included in transaction request 201. One example of such a mobile device identification server is described in detail in U.S. patent Ser. No. 16/102,624, filed Aug. 13, 2018 and entitled “Mobile Number Verification for Mobile Network-Based Authentication,” which is incorporated herein by reference in its entirety.

In a second portion of the multi-factor authentication process, identity verification server 150 verifies that the initiation location of the online transaction associated with transaction request 201 matches the current location of mobile device 120 by determining the initiation location of the online transaction and the current location of mobile device 120. In some embodiments, identity verification server 150 determines the initiation location of the online credit card transaction based on an IP address of computing device 110 included in transaction request 201. In some embodiments, identity verification server 150 determines the current location of mobile device 120 based on location information included in user account information 204, which originates from cellular network provider 140. Alternatively, identity verification server 150 determines the current location of mobile device 120 via global positioning system (GPS) information received from mobile device 120 and/or included in transaction request 201. Identity verification server 150 then verifies whether the initiation location of the online transaction associated with transaction request 201 matches the current location of mobile device 120. In this way, the currently registered user of mobile device 120 is verified to be located at the initiation location of the online transaction, indicating that the credit card transaction is an authorized transaction and not a fraudulent transaction.

As used herein, two geographical locations “match” each other when the two geographical locations are determined to be within a predetermined distance of each other. The predetermined distance can be on the order of a few meters, hundreds of meters, or up to multiple kilometers, depending on various factors, such as the expected precision with which the current location of mobile device 120 and the initiation location of the online transaction can be determined.

In a third portion of the multi-factor authentication process, identity verification server 150 verifies that the user name included in request for identity verification 202 matches a name currently registered as a user name for the credit card account number included in user account information 204. That is, identity verification server 150 verifies that the name of the currently registered user of mobile device 120 matches the name of the currently registered user of the credit card account associated with transaction request 201. First, identity verification server 150 transmits a query 205 to one or more credit bureau servers 160, where query 205 includes the user name included in user account information 204 and the credit card account number included in request for identity verification 202. The one or more credit bureau servers 160 each determines whether the user name included in user account information 204 matches the name of the currently registered user of the credit card account number included in request for identity verification 202. The one or more credit bureau servers 160 then transmit a reply 206 indicating whether the name of the currently registered user of the credit card account number matches the user name included in user account information 204.

It is noted that ownership of mobile device 120 can be updated by cellular network provider 140 almost instantaneously, for example within a few minutes after a user reports mobile device 120 to be stolen or requests that the mobile account associated with mobile device 120 be deactivated. Thus, matching of the user name included in user account information 204, which is provided by cellular network provider 140, with the name of the currently registered user of the credit card account number indicates with high confidence that transaction request 201 has not been initiated by a fraudster with a stolen mobile device 120.

Additionally, in some embodiments, identity verification server 150 further verifies that other user account information included in user account information 204 matches corresponding user account information associated with the currently registered user of the credit card account number referenced in transaction request 201. For example, personal identifying information employed in such embodiments may include a complete address (e.g., number, street, city, state, and zip code) associated with the currently registered user of the credit card account number referenced in transaction request 201 and included in user account information 204. Thus, unlike a conventional address verification service (AVS) available to online merchants, embodiments of the invention can verify the identity of the user of mobile device 120 based on a complete address check, rather than a zip code check.

In some embodiments, in a final portion of the multi-factor authentication process, identity verification server 150 determines an authorization score 207 for the on-line transaction based on the above verification steps. Thus, rather than a simple pass-fail authentication process, in such embodiments identity verification server 150 determines an authorization score selected from a continuum of possible values that indicate the reliability of the credit-card transaction associated with transaction request 201.

Upon completion of the above-described multi-factor authentication process, identity verification server 150 then transmits authorization score 207 to application server 130. Based on authorization score 207, application server 130 determines whether or not to allow the credit-card transaction associated with transaction request 201 to proceed. Thus, mobile identity verification system 100 is configured to prevent or minimize the risk of fraudulent online transactions involving a stolen credit card number via multi-factor authentication of the online transaction.

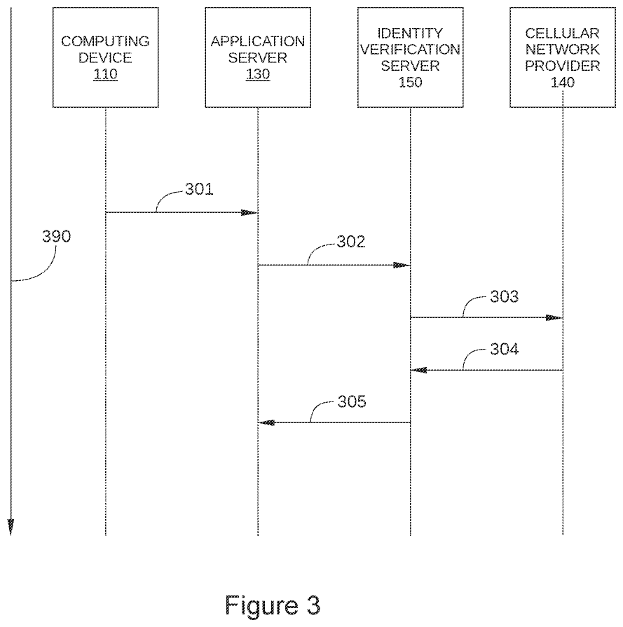

According to various embodiments described below, the identity of a person attempting to open an account, such as a credit card account, via computing device 110 can be verified via a multi-factor authorization scheme. In such embodiments, the multi-factor authorization scheme is based on the network ID of a mobile device 120. More specifically, the identity of the user attempting to open the account can be verified by comparing the user name referenced in the account registration with the name that is currently registered as the user name for mobile device 120. The identity of the user attempting to open the account can be further verified by comparing the current location of the user attempting to open the account with the current location of the mobile device. An identity verification score for the user attempting to open the account can then be determined based on such identity verification. One such embodiment is described below in conjunction with FIG. 3.

FIG. 3 schematically illustrates the steps performed by mobile identity verification system 100 when performing multi-factor identity verification, according to one or more embodiments of the invention. The steps occur sequentially along a time line 390. As described above, mobile identity verification system 100 enables electronic verification of the identity of a user attempting to open an account via a multi-factor authorization scheme.

When a user of computing device 110 attempts to open an account associated with application server 130, such as a credit card account, computing device 110 transmits a registration request 301 to application server 130. For example, after a connection is established between computing device 120 and application server 130, a user may fill out an online registration form displayed on a display device of computing device 110 to initiate registration request 301. The online registration form may be displayed by, for example, vendor application 115 or web browser 116 when connected to application server 130. Registration request 301 can include a user name and additional person identifying information, such as a date of birth of the user, the last four digits of the social security number of the user, and the like. In some embodiments, registration request 201 further includes a mobile device network ID for a mobile device 120 that is operated by the user attempting to open the account.

Upon receipt of registration request 301, application server 130 then transmits a request for identity verification 302 to identity verification server 150. Request for identity verification 302 generally includes the user name. In some embodiments, request for identity verification 302 further includes the network ID of mobile device 120, where mobile device 120 is a mobile device for which the user attempting to open the account is currently the registered user.

Upon receipt of request for identity verification 302, identity verification server 150 performs a multi-factor authentication process that includes: verifying the user name included in request for identity verification 302 matches the user name currently registered as a user name for the network identification ID of mobile device 120; and verifying the current location of the user attempting to open the account matches a current location of mobile device 120. The multi-factor authentication process may further include determining an identity verification score for the identity of the user attempting to open the restricted access account, where the identity verification score is based on the above verification steps. Performance of the above verification steps can be in any technically feasible order, and are described herein in one example order.

In a first portion of the multi-factor authentication process, identity verification server 150 verifies that the user name included in request for identity verification 302 matches the user name currently registered as a user name for the network identification ID of mobile device 120. Specifically, identity verification server 150 transmits a user profile information request 303 to the cellular network provider 140 that manages the network ID referenced in request for identity verification 302. In some embodiments, the user profile information request 303 includes a request for the name and address of the primary user of the mobile account associated with the network ID referenced in request for identity verification 302. In some embodiments, identity verification server 150 first determines the cellular network provider 140 that manages the network ID referenced in request for identity verification 302, for example based on the network ID. Identity verification server 150 then receives user account information 304 from cellular network provider 140, where user account information 304 includes, for the mobile account associated with the network ID, a mobile account user name and, in some embodiments, a mobile account user address. In some embodiments, user account information 304 further includes current location information for mobile device 120. Identity verification server 150 then verifies whether the user name included in request for identity verification 302 matches the user name included in user account information 304.

In embodiments in which the attempt to open the account is initiated via mobile device 120, computing device 110 and mobile device 120 can be the same device. In such embodiments, identity verification server 150 or application server 130 can determine network ID automatically, as set forth above in conjunction with FIG. 2.

In a second portion of the multi-factor authentication process, identity verification server 150 verifies that the current location of the user attempting to open the account associated with registration request 301 matches the current location of mobile device 120 by determining the current location of the user attempting to open the account and the current location of mobile device 120. Identity verification server 150 can determine the current location of the user attempting to open the account and the current location of mobile device 120 in the same fashion as set forth above in conjunction with FIG. 2.

Additionally, in some embodiments, identity verification server 150 further verifies other user account information included in user account information 304 matches corresponding user account information included in registration request 301. For example, personal identifying information employed in such embodiments may include a complete address (e.g., number, street, city, state, and zip code). Thus, unlike a conventional AVS available to online merchants, embodiments of the invention can verify the identity of the user of mobile device 120 based on a complete address check, rather than a zip code check.

In some embodiments, in a final portion of the multi-factor authentication process, identity verification server 150 determines an identity verification score 305 for the user attempting to open the account based on the above verification steps. Thus, rather than a simple pass-fail authentication process, in such embodiments identity verification server 150 determines an authorization score selected from a continuum of possible values that indicate the reliability of the user identity associated with registration request 301.

Upon completion of the above-described multi-factor authentication process, identity verification server 150 then transmits identity verification score 305 to application server 130. Based on identity verification score 305, application server 130 determines whether or not to allow the credit-card transaction associated with registration request 301 to proceed. Thus, mobile identity verification system 100 is configured to prevent or minimize the risk of fraudulent account set-ups with stolen mobile devices used in conjunction with stolen personal identifying information.

In sum, embodiments described herein enable multi-factor authentication and multi-factor identity verification to enhance security of online transactions and reduce fraud. Based on the network ID of a mobile device belonging to a user initiating an online payment transaction, the identity of the user can be verified based on the location of the user and the mobile device, the name of the user and the name of the currently registered user of the mobile device, and user information associated with the account used to initiate the transaction and corresponding account information associated with the mobile device. Thus, by electronically verifying that real-time user account information associated with a mobile device matches user account information associated with an online payment transaction, the embodiments described herein provide at least one technological improvement over prior art techniques, which can be readily circumvented by fraudsters in possession of a stolen credit card number used in conjunction with stolen identity information.

While the foregoing is directed to embodiments of the present invention, other and further embodiments of the invention may be devised without departing from the basic scope thereof, and the scope thereof is determined by the claims that follow.

1. A computer-implemented method of authenticating a user logged into a restricted-access account over a computer network, the method comprising:
receiving a request to authenticate the user over the computer network;
verifying that authentication data of the user matches verification data that is acquired over the computer network and associated with a network identification of a mobile device that is linked to the restricted-access account of the user;
verifying that a location of an IP address from which the user is accessing the restricted-access account matches a current location of the mobile device; and
authenticating the user upon determining that the authentication data of the user matches the verification data and the location of the IP address matches the current location.

2. The method of claim 1, further comprising, prior to verifying that the location of the IP address from which the user is accessing the restricted-access account matches the current location of the mobile device, determining the current location of the mobile device.

3. The method of claim 2, wherein determining the current location of the mobile device comprises:
upon receiving the request for authenticating the user, determining a mobile provider that manages the network identification of the mobile device;
transmitting a request for the current location of the mobile device to the mobile provider; and
receiving the current location of the mobile device from the mobile provider.

4. The method of claim 3, wherein the authentication data of the user includes the network identification of the mobile device.

5. The method of claim 1, further comprising transmitting a notification to an application server of the authentication of the user.

6. The method of claim 1, wherein the authentication data includes first additional user information associated with the restricted-access account and the method further comprises verifying that the first additional user information matches second additional user information that is associated with the network identification of the mobile device.

7. The method of claim 6, wherein the first additional user information comprises street address information associated with the user accessing the restricted-access account and the second additional user information comprises street address information for a user associated with the network identification of the mobile device.

8. The method of claim 1, wherein the restricted-access account is associated with an application server.

9. The method of claim 1, further comprising determining that a first user name associated with the restricted-access account matches a second user name that is currently registered as the user of the network identification of the mobile device.

10. The method of claim 9, wherein determining that the first user name matches the second user name comprises receiving, for a mobile account associated with the network identification of the mobile device, a mobile account user name, and further comprising receiving, for the mobile account associated with the network identification, a mobile account user address.

11. A multi-factor authentication method using a mobile device as a token to protect against fraudulent on-line purchases, the method comprising:
receiving at an authentication server, a request for authorization of an on-line transaction from an application server associated with a restricted-access account, wherein the on-line transaction is initiated by the mobile device using the restricted-access account, the request including a first user name associated with the restricted-access account, an IP address of the mobile device that initiated the on-line transaction, and an account number identifying a payment account for the on-line transaction;
verifying at the authentication server, that the first user name matches a second user name currently registered as a user name for a network identification (ID) of the mobile device, wherein the network ID of the mobile device is determined from a link between the network ID of the mobile device and the restricted-access account;
verifying at the authentication server, that an initiation location of the on-line transaction matches a current location of the mobile device, wherein the initiation location of the on-line transaction is determined from the IP address included in the request;
verifying at the authentication server, that a third user name registered as a user name for the payment account matches the first user name;
determining at the authentication server, an authorization score for the on-line transaction based on verifying that the first user name matches the second user name, verifying that the initiation location of the on-line transaction matches the current location of the mobile device, and verifying that the third user name matches the first user name; and
transmitting by the authentication server, the authorization score to the application server, which determines whether or not to allow the on-line transaction to proceed.

12. The method of claim 11, wherein the on-line transaction is associated with the restricted-access account, and the network ID of the mobile device is linked to the restricted-access account prior to the receiving of the request for authorization of the on-line transaction.

13. The method of claim 11, further comprising, prior to verifying that the initiation location of the on-line transaction matches the current location of the mobile device, determining the current location of the mobile device.

14. The method of claim 13, wherein determining the current location of the mobile device comprises:
upon receiving the request for authorization of the on-line transaction, determining a mobile provider that manages the network ID of the mobile device;
transmitting a request for the current location of the mobile device to the mobile provider; and
receiving the current location of the mobile device from the mobile provider.

15. The method of claim 14, wherein the request for authorization of the on-line transaction includes the network ID of the mobile device.

16. The method of claim 14, the method further comprising extracting the network ID of the mobile device from communications received from the mobile device.

17. The method of claim 13, wherein determining the current location of the mobile device comprises receiving global positioning system (GPS) information from the mobile device.

18. The method of claim 17, wherein verifying that the third user name registered as the user name for the payment account matches the first user name comprises:
transmitting to a credit bureau the first user name and the account number identifying the payment account; and
receiving an acknowledgement from the credit bureau that the third user name registered as the user name for the payment account matches the first user name.

19. The method of claim 11, wherein verifying that the third user name registered as the user name for the payment account matches the first user name comprises:
transmitting to a credit bureau personal identifying information included in the request for authorization of the on-line transaction and the first user name associated with the restricted-access account; and
receiving an acknowledgement from the credit bureau that, based on the personal identifying information, the third user name registered as the user name for the payment account matches the first user name.

20. The method of claim 19, wherein the personal identifying information includes at least one of a date of birth of a user, at least a portion of a social security number of the user, and the account number identifying the payment account.
